(19) United States
(12) Patent Application Publication
(10) Pub. No.: US 2006/0016047 A1
(43) Pub. Date: Jan. 26, 2006

(54) Locking hinge connector apparatus

(76) Inventors: Gary Palmer Blackman, Carmel Valley, CA (US); Kent Brian Zilliox, Carmel Valley, CA (US)

Correspondence Address: Kent Zilliox, 4 Buena Vista Del Rio #A, Carmel Valley, CA, 93924, US

(21) Appl. No.: 11/171,836

(22) Filed: Jun. 29, 2005

Related U.S. Application Data
(60) Provisional application No. 60/585,247, filed on Jul. 1, 2004.
(60) Provisional application No. 60/667,909, filed on Mar. 25, 2005.

(51) Int. Cl. E05D 15/50

(52) U.S. Cl. 16/231

(57) ABSTRACT

A connector apparatus which comprises two main connector parts, pivotally joined by a hinge mechanism, enabling a first part of the connector apparatus to be pivoted into an angled orientation position relative to the second connector part. Together with a hinge mechanism the connector apparatus can include an integral locking mechanism, such that the two main connector parts can be pivoted into a desired relative orientation and then locked into place. The user can easily unlock, pivot, and then lock the hinge mechanism in a desired relative orientation, allowing the device to be switched between straight, and angled orientations very quickly. In one embodiment, a connector apparatus is made to attach a pole handle, such as a swimming pool cleaning apparatus handle, on the first main connector part, and where the second main connector part attaches to a swimming pool skimmer net or brush.

### RELATED APPLICATIONS

This Utility Patent Application for “Locking Hinge Connector Apparatus” filed on Jun. 29, 2005 is a Continuation-in-Part to U.S. Provisional Patent Applications Nos. 60/585,247 filed Jul. 1, 2004 and 60/667,909 filed Mar. 25, 2005 and claims the benefit of the priority dates of those two U.S. Provisional Patent Applications. The aforementioned U.S. Provisional Patents Applications Nos. 60/585,247 and 60/667,909 hereby incorporate by reference in their entirety and for all purposes into this Patent Application.

This Patent Application filed on Jun. 29, 2005 is also hereby cross-referenced to and incorporates by reference the separate Utility Patent Application titled, “Quick Change Pole End Attachment Connector” invented by the same two co-inventors Gary Blackman and Kent Zilliox, and filed on the same date of filing with the present Patent Application for “Locking Hinge Connector Apparatus.”

### FIELD OF THE INVENTION

The present invention relates to an apparatus for quickly changing devices attached to a handle, and more particularly for quickly changing the orientations of the attached devices to the attached handle.

### BACKGROUND OF THE INVENTION

There are many different manual operations that can be performed by those people interested in using a device attached to a handle such as an extension pole. However, with common extension poles, many devices for pole attachment, such as swimming pool skimmers, are designed in a fixed direction from the line of the pole, often in straight line with the direction of the pole. However, such common fixed-direction pole attachment devices are typically limited to a single orientation of usage, some of which may not be feasible for certain desired operations, or are strenuous for a person using long handle pole devices.

For instance, in the swimming pool industry a main component of routine maintenance is removal of debris anywhere from within the body of water in the pool. Debris removal is typically accomplished with the use of a skimming apparatus, which is commonly comprised of a telescoping pole, with a handle at one end, and at the other end of the pole is typically a net device attached to its outer end. This simple net device has been a standard tool in the swimming pool industry for many years and is commonly referred to as a “skimmer” or “skimmer net.” It is used by pool owners and professional maintenance personnel alike. The device often contains few or no moving parts, yet it offers several design features, enabling it to capture debris floating close by or adhering to the side of the pool, debris floating farther out on the water surface, debris suspended anywhere below the surface and debris lying on the bottom of the pool.

The net (skimmer net) device may consist of a specialized hoop with a net attached to the entire perimeter of the hoop and an industry-standard attachment handle, designed to attach to any industry-standard pole. The net may vary in depth from very shallow to quite deep, depending on the amount of debris it's intended to capture and contain.

The hoop itself, which is often more rectangular than circular, may have sharp edges on three of its sides, enabling the device to scrape debris adhering to the side of the pool and debris lying on the bottom of the pool. The sharp edges on either side of the hoop are used to scrape and capture debris adhering to the side of the pool, while the sharp leading edge is used to scrape and capture debris lying on the bottom of the pool. Debris scraped in this manner mostly flows into the attached net and is immediately captured and contained therein.

The orientation of the hoop opening in many common skimmers, is generally parallel with the attached pole, similar to a butterfly net, and is useful in several types of orientations. For example, when scraping debris from the side of the pool, this orientation requires the user to stand very close to the edge of the pool and operate the device from directly above. In this manner, one side of the hoop is held against the side of the pool and moved forward. Line-of-sight visibility between the user and the skimmer/poolside contact point is somewhat obscured by overhanging the or coping surrounding typical pools. This orientation also requires the user to apply force in two directions: pressing the device against the side of the pool to maintain the scraping action and pushing the device forward, all while slightly leaning over the edge of the pool to maintain visual contact with the process.

In another type of usage with a pole and skimmer, the parallel orientation of the hoop opening to the attached pole enables the user to push the device along the bottom of the pool so its sharp leading edge can scrape debris into the attached net. During this bottom-scraping operation, the user pushes the device from a point on the bottom nearest to him outward to the limit of the reach of the attached pole. The device is then pulled back toward the user, pushed back down against the bottom of the pool, then out again, away from the user. The process is often repeated until the debris lying of the bottom of the pool is collected.

The parallel orientation of the hoop opening to the attached pole also enables the user to collect debris both floating on the surface of the water and suspended below the surface. The user can manipulate the device to capture debris in a side-to-side motion, a lifting motion or a downward motion. While effective, the user must accomplish these side-to-side and up-and-down motions from the end of a long pole. This cantilevered operation of the pole can be quite fatiguing, since it places reversed-leverage forces on the user. Thus there is a need for the inventive pole connection apparatus to allow for at least one device to be connected at a non-linear angle relative to the handle, such as perpendicular to a pole handle. These additional pole orientations allow routine maintenance tasks to be accomplished more quickly and with less physical effort. Furthermore, it would be even more useful to have a connection apparatus which can be easily reset and locked into various desired angles of relative orientations.

### SUMMARY OF THE INVENTION

The apparatus is designed to simultaneously reduce back strain and fatigue and increase the effectiveness of long pole handle and attachment operations, although there are many other uses and benefits.

The connector apparatus comprises two main connector parts, pivotally joined by a hinge mechanism, enabling a first part of the connector apparatus to be pivoted into an angled orientation position relative to the second connector part. Together with a hinge mechanism the connector apparatus can further include an integral locking mechanism, such that the two main connector parts can be pivoted into a desired relative orientation and then locked into place. In a preferred embodiment example used for descriptive purposes herein, such a connector apparatus is made to attach to a pole handle on the first connector part, and where the second main connector part can attach to a useful device such as a swimming pool skimmer net or brush, or other useful type of device. The user can easily unlock and lock the hinge mechanism in each relative position orientation, allowing the device of this embodiment to be switched between straight, 135 degree angled orientation, perpendicular, or other orientations very quickly. The speed and ease of the unlocking-locking operation can be very convenient for certain maintenance professionals or anyone trying to do something with a particular device in a hard to reach area.

The quick change locking hinge connection apparatus in a most basic form comprises two main connection portions, pivotally joined to allow a change of angle relative to between the two connector portions, thus changing the direction of operation of an attached device relative to the direction of the handle, such as in the example of usage with a pool skimmer basket connected ninety degrees relative to a pole handle, then reset and locked to quickly transform the effective angle of the tool relative to the handle, such as to a linear direction.

Other types of handles besides straight poles can be used with the invention, although pole handles are used commonly herein as examples in describing some possible usages of the invention. A short handle body with a hand grip could also be made suitable to work with the invention as could other handle types which are known or can be developed by those skilled in the art.

In a quick change locking hinge connection apparatus pole end embodiment example of a swimming pool skimmer, the apparatus can connect to many kinds of industry-standard device attachments. The locking hinge connector apparatus can be secured between the outer end of a telescoping pole and a skimmer device. In this example, the male connector of an industry-standard skimmer connects to the female side of the connection apparatus. The male side of the connector apparatus in turn, connects to the female connector of any industry-standard pole. The user can easily connect and disconnect various attachment tools and devices, allowing him to switch between desired tools such as various skimmer nets and scrub brushes very quickly. This speed and ease of the connecting and disconnecting operation, while convenient for pool owners, is especially important for pool maintenance professionals, who must account for their time on each job. Once any of the devices are attached, the hinge mechanism can be unlocked, pivoted, then relocked into the new desired orientation, giving excellent flexibility of usage for a wide variety of tools and devices.

In the pool skimmer embodiment example, during a side-scraping operation with the device in a perpendicular, ninety-degree orientation, the device enables the user to walk ahead of the skimmer, trailing the pole behind him, pulling the skimmer along the sidewall of the pool. By walking a path a foot or two from the side of the pool, the pole is angled away from the pool (toward the side), which, with the resulting angle of attack, automatically keeps the skimmer pressed against the side while it scrapes debris into the net.

Pulling rather than pushing the skimmer around the perimeter of the pool allows the operation to proceed more quickly. In addition, pulling the skimmer in only one direction, requires less force to be applied and relieves back strain, compared to the conventional method without an angled connector, of holding the pole in a vertical orientation and pushing the skimmer through the water. The increased speed made capable with the angled connector, has the additional benefit of creating a temporary swirling current within the pool. This swirling action helps consolidate debris floating farther out on the pool surface, enabling more efficient capture.

Ninety-degree orientation, 135 degree orientation, linear orientation, and other angles of significantly nonlinear dimensions between the skimmer to the pole can also be used in particular instances to enhance capture of debris floating near the center potion of the surface of the water. In the ninety degree orientation, the skimmer is tossed through the air to land beyond the debris. The skimmer is then pulled back in, toward the user, with its opening facing the direction of travel. In this manner, any debris floating between the user and the landing point of the skimmer is captured and retained in the skimmer net.

If the user requires the skimmer hoop opening to be retuned to a linear or parallel orientation, he can unlock the hinge mechanism on the connector apparatus, pivot the connectors relative to each other, then relock the connector apparatus into the new desired orientation with the skimmer net oriented in a parallel position relative to the handle. Since parallel orientation is required for at least the bottom scraping operation, it is anticipated the user will use the skimmer in both orientations during an entire pool cleaning operation.

In yet another highly useful embodiment, two or more devices can be attached at the same time, such as a floatation device and a skimmer can both be attached to some embodiments of the inventive apparatus, which is then in turn attached to such a long poled handle. Then, with the apparatus turned such that the skimmer faces upwards, out of the water, the pole is used to push the apparatus with skimmer and float far out across the surface of the pool to a desired location. Next the pole handle is rotated to allow the skimmer to extend downwards into the water, and the floating skimmer and apparatus can easily then be pulled back across the surface, gathering the desired floating leaves or such debris. In another multiple device example, a brush and a skimmer net (and/or other devices) can be attached to a pole handle to perform two operations at once, or in rapid sequential order without changing devices.

In the pool skimmer embodiment example, the male end of the apparatus is built to fit the size and dimensions to connect to any industry-standard swimming pool cleaning pole. The female end of a pole connector apparatus is built for the correct size and dimensions to accept the standard male type connectors used for many industry-standard skimmers and other maintenance devices.

The inventive pivot able hinge connection apparatus can be designed and made in numerous types of embodiments. In the swimming pool industry example, the various embodiments are mostly related to the standard pool cleaning type pole connectors of approximately 1.125 inches diameter. In other industries, the various embodiments may relate to other styles of device attachment. For example, the connectors can be made to accommodate attachments common to many tasks, such as threaded connectors. Furthermore, the device can be manufactured in various sizes and specifications, depending on its intended use. The male and female connection portions of the device can embody various shapes. The male and female connectors in versions intended for use in the swimming pool industry are industry standard to fit virtually any standard pole or skimmer. In uses contemplated for other industries, the device can function in various configurations and shapes. In the preferred embodiment for use in the swimming pool industry, said apparatus including the male and female connector ends are made of molded plastic and the spring connector is made of nylon-type molded plastic. All or part of the connector apparatus can also be made of aluminum tubing, of industry standard dimensions. Other materials, such as metal, wood, plastic, Plexiglas, wood, rubber, or any material suitable for construction and durable enough for usage of the device, can also be employed. One embodiment of particular usage may comprises at least one connector end to have a plastic or metal threaded connector, such as to fit with paint roller handles, scrapers, push-brooms and other types of useful devices.

The pivoting apparatus can also be built in other embodiments for stationary device usage, such as for mounting lights, cameras or video equipment, where a quick change from a first locked orientation to a second angled orientation can be quickly and easily performed. In these types of useful embodiments the apparatus can be designed and built with suitable connectors to match the connector type of the device to be pivotable employed.

Furthermore, additional embodiments for this useful invention can include a pivotable apparatus where both ends of the hinged mechanism are fixed and non-removable, yet the relative orientation of the two parts can be changed from one relative angle to another and locked into place at the desired relative orientation.

### BRIEF DESCRIPTION OF THE DRAWINGS

FIG. 1 shows a spring-action quick connecting locking hinge connector apparatus, set to an angle of relative orientation between the two connector ends, of approximately 90 degrees.

FIG. 2 shows a locking hinge connector apparatus with the center hinge/locking pins in a locked state with the two connector ends in a straight orientation.

FIG. 3 shows a locking hinge connector apparatus with the center hinge/locking pins depressed in an unlocked state and the two connector ends free to be rotated to a new orientation.

FIG. 4 shows an exploded view of a portion of a locking hinge connector apparatus with one of the center hinge/locking pins lined up with the corresponding shaped openings of each of the two connector ends.

FIG. 5 shows the Locking Hinge Connector in a locked state, with the center hinge/locking pin apparatus tensioned with a coiled spring. FIGS. 5A and 5B show two various center hinge/locking pin configurations.

FIG. 6 shows various matching pin and corresponding hole patterns for the center hinge/locking pins.

FIG. 7 shows a spring-action quick connecting locking hinge connector apparatus, set to an angle of relative orientation between the two connector ends of approximately 90 degrees. This embodiment shows locking pins separate from center hinge pins. Also shown are small ramps or flares on the outer end of the female connector which helps to guide both the male and female fittings together, and depress industry-standard apparatus locking pins toward their respective holes.

FIG. 8 shows a spring-action quick connecting locking hinge connector apparatus set at different angles. FIG. 8A shows the connector apparatus locked in a straight-out configuration. FIG. 8B shows the connector apparatus locked in a 45-degree configuration and FIG. 8C shows the connector apparatus locked in a 90-degree configuration.

FIG. 9 shows an exploded view of a spring-action quick connecting locking hinge connector apparatus where the locking pin apparatus is tensioned with a coiled spring and the locking pins are located in a circular array about the center hinge pin.

FIG. 10 shows variations of a locking hinge connector apparatus, with tapered and non-tapered locking pins and receiving holes, where the locking pins are located in a circular array about the center hinge pin.

FIG. 11 shows the locking hinge connector apparatus with a fixed pole handle on one connector end, and where a attachable/detachable connection can be made between the second connector end and a device to be attached, such as a brush, net, paint roller, vacuum head, video camera or other useful mechanical devices.

FIG. 12 shows a locking hinge connector apparatus with a fixed device on one end of the hinge mechanism, and with an attachable/detachable connector on the other end, such as to connect to a pole or handle by means of a threaded method of attachment.

FIG. 13 shows a locking hinge connector apparatus with a fixed device on one end of the hinge mechanism, and with an attachable/detachable male connector on the other end, such as to be received by a female connector on a pole or handle and locked in place by means of spring connector pins.

FIG. 14 shows a locking hinge connector apparatus fixed to both a pole handle on one end, and an apparatus on the other end, where both ends are fixedly attached and non-removable.

FIG. 15 shows a locking hinge connector apparatus fixed to an apparatus on one end and, with an attachable/detachable male connector on the other end, such as to be received by a female connector on a pole or handle and locked in place by means of spring connector pins.

FIG. 16 shows two locking hinge connector apparatuses assembled in a series to give a complex multidimensional angle between a handle and an attached device.

FIG. 17 shows locking hinge connector apparatuses used in a boat cleaning process where the attached device (a brush) is orientated at 45 degree and 90 degree angles to the long handled pole.

FIG. 18 shows a locking hinge connector apparatus where a shorter extension is connected between the locking hinge connector apparatus and the attached device for use in difficult to reach areas.

FIG. 19 shows a locking hinge connector apparatus joining two long handled poles in a 90 degree configuration for use in a measuring process in difficult to reach areas.

FIG. 20 shows two locking hinge connector apparatuses assembled in a series to give a complex multidimensional angle between a handle and an attached device.

FIG. 21 shows different connector configurations including FIG. 21A female to female,

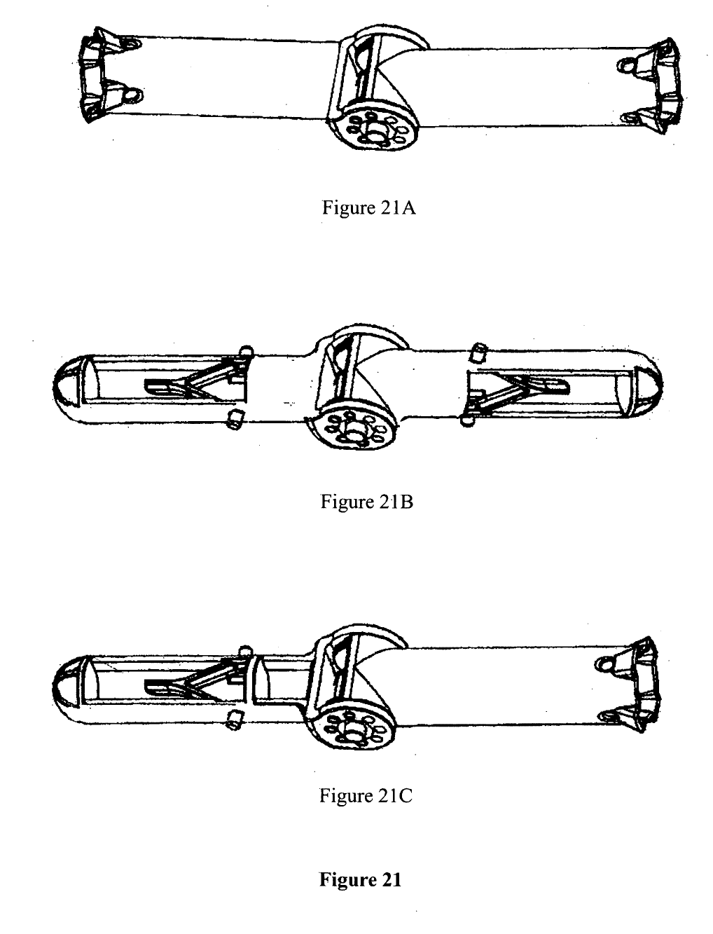

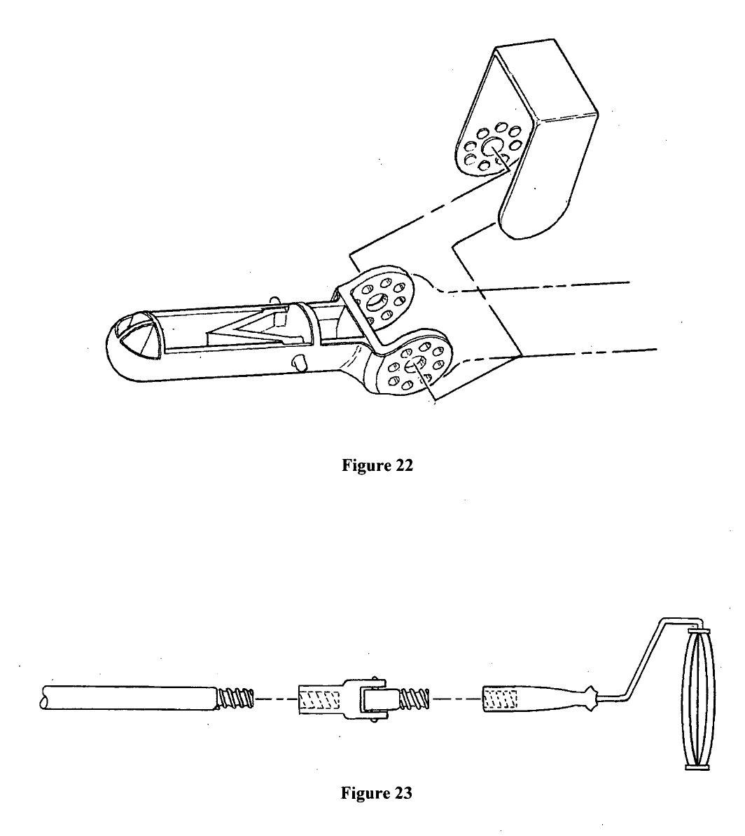

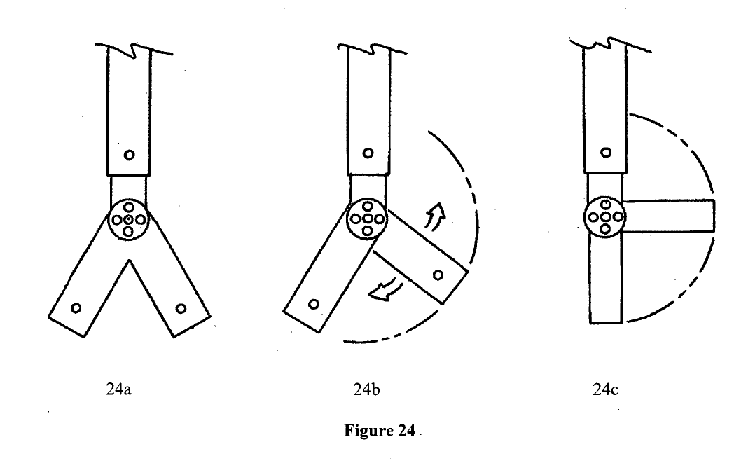

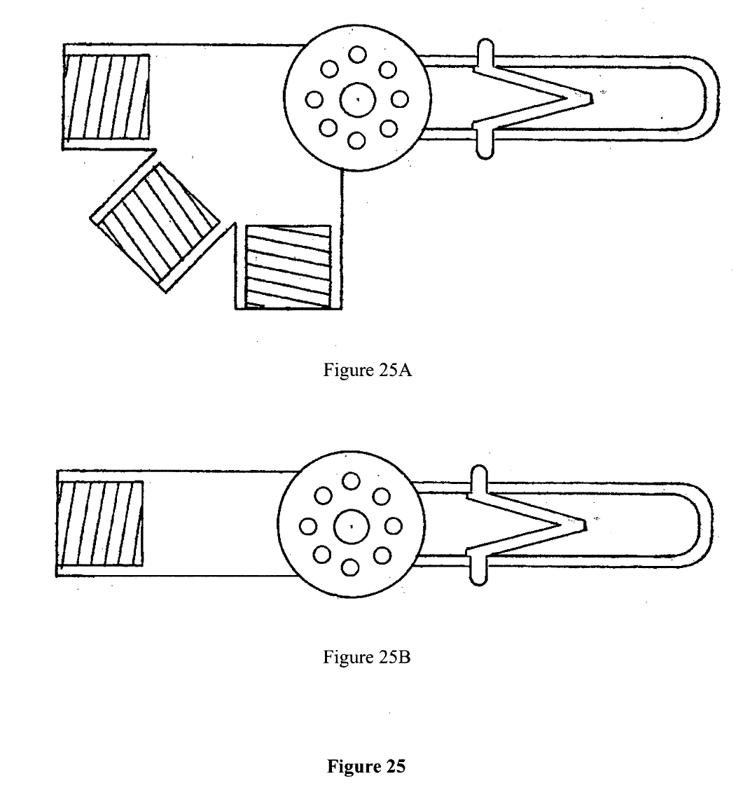

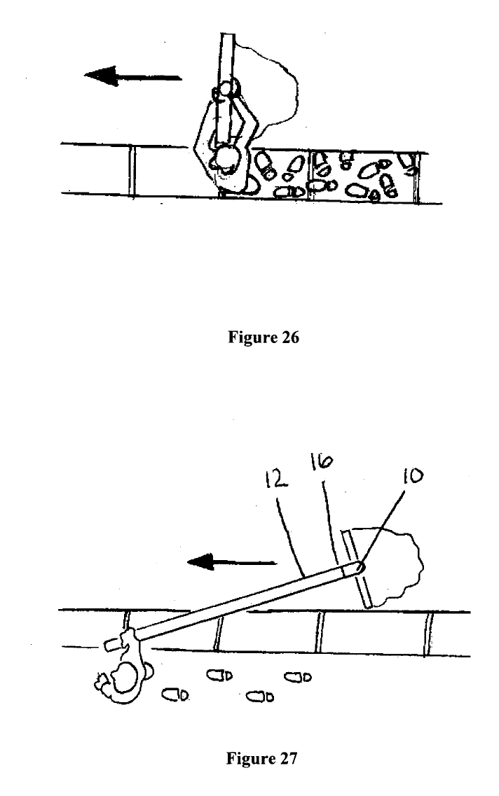

FIG. 2I B male to male and FIG. 21C male to female connector ends, such as the types used in standard swimming pool cleaning handles and devices.

FIG. 22 shows an example of a locking hinge connector apparatus where a separate piece is used to hold the locking pins in an unlocked configuration where the locking hinge connector apparatus is made to swing freely. Another embodiment of the unlocking function would employ a component integral with the locking hinge connector apparatus.

FIG. 23 shows a locking hinge connector apparatus designed to connect to a handle one end and to a device on the other end, where both connector ends are designed with threaded connection fittings such as commonly found for use with paint rollers, scrapers, push brooms and other useful tools and devices. In some embodiments such threaded connections could be designed and sized to match with and attach to cameras, video equipment, tripod stands, telescopes and other useful devices.

FIG. 24 shows a locking hinge connector apparatus where various pivoting ends (FIGS. 24A, 24B and 24C) can receive device attachments.

FIG. 25 shows two various locking hinge connector apparatuses where a male connector end attaches to a pole handle (FIG. 25B) and one or more female connector ends at fixed angles (FIG. 25A) relative to each other are pivotally attached and where the female connector ends can receive devices by means of a threaded attachment mechanism.

FIG. 26 shows an operator during a sidewall cleaning process sidestepping parallel to the edge of a swimming pool manipulating a long handled pole connected directly (without locking hinge connector apparatus) to a standard skimmer net where the skimmer net is aligned parallel to the pole.

FIG. 27 shows an operator during a sidewall cleaning process walking parallel to the edge of a swimming pool pulling a long handled pole and a locking hinge connector apparatus holding a standard skimmer net in a 90 degree orientation to the pole handle with an inward angle of attack of the skimmer net relative to the sidewall of the pool.

### DETAILED DESCRIPTION OF THE INVENTION

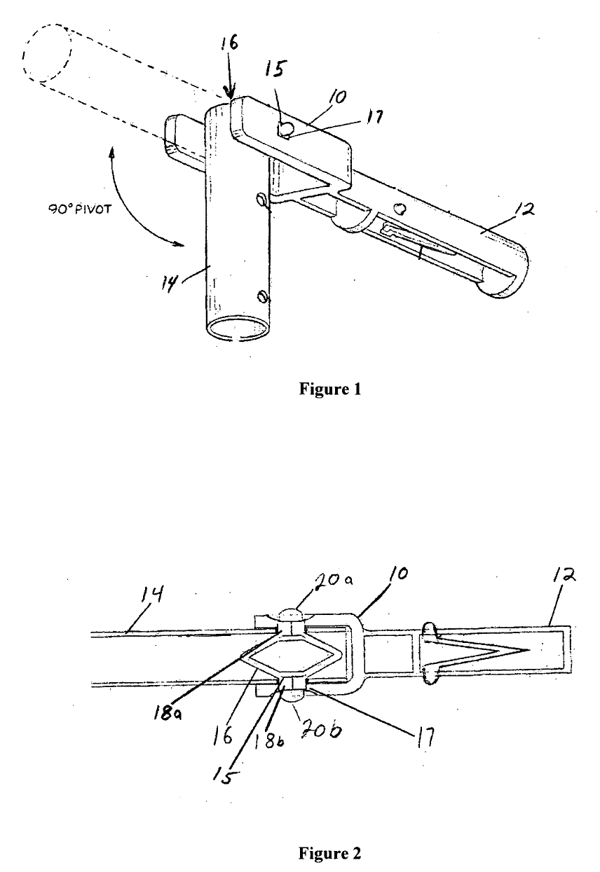

A locking hinge connector apparatus 10 as shown in FIG. 1 comprises two main connector parts 12 and 14, pivotally joined by a hinge mechanism 15 which in some embodiments can be integrally incorporated with a spring mechanism 16, enabling the first connector part 12 of the apparatus 10 to be pivoted into an angled orientation position relative to the second connector part 14. The hinge mechanism 15 need not be composed of the same part as the spring mechanism 16, although in this embodiment both are integral within a single plastic part as depicted in FIG. 1. Together with the hinge mechanism 15 the connector apparatus 10 can further include an integral locking mechanism 17, also known as a locking/unlocking mechanism, such that the hinge between the two main connector parts 12 and 14 can be locked or unlocked, and while unlocked can be pivoted into a desired relative orientation and then locked into place to prevent relative pivoting of the two main connector parts, until unlocked again. The hinge 15 and locking mechanism 17 need not incorporate a spring, although a spring loaded locking mechanism 17 provides for a useful quick release operation of the locking mechanism 17.

As shown in FIG. 2, two locking pins 18a and 18b, and two rounded spring loaded push buttons 20a and 20b are built into the spring mechanism 16. Each of the aforementioned component pieces 12, 14, 15, 17, 18a, 18b, and 20a and 20b used in this embodiment of a spring loaded, quick release locking hinge connector apparatus 10 can be made of molded plastic, or of metal, or other suitable materials known or used by those skilled in the arts. Similarly other hinging and locking features can be employed as are known or can be devised by those skilled in the art.

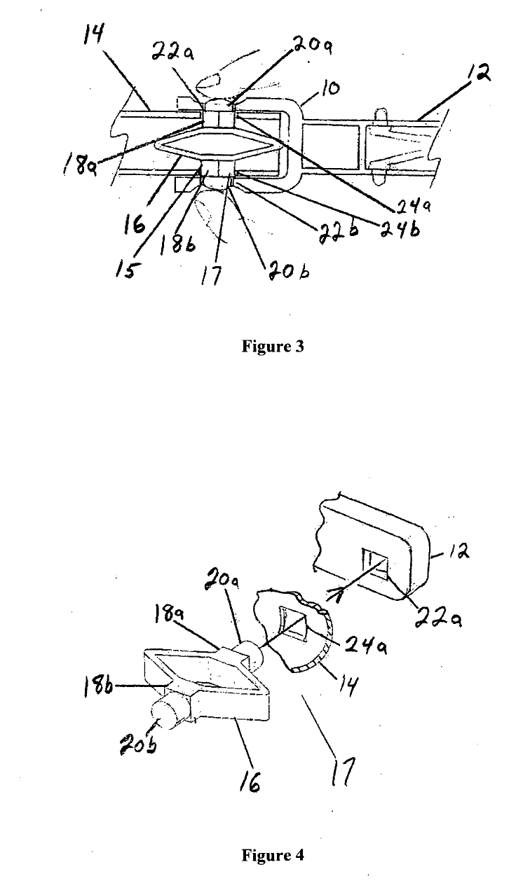

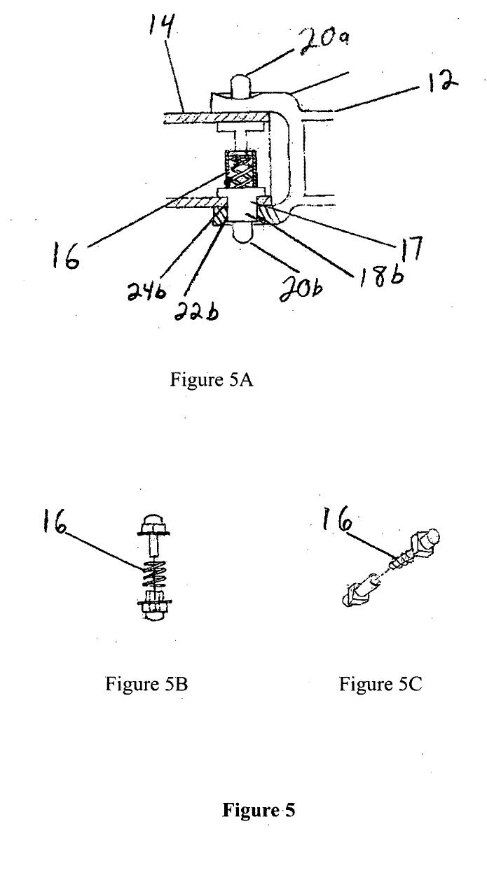

The central spring mechanism 16 shown in FIGS. 2, 3, and 4, allows the user to easily depress the push buttons 20a and 20b, allowing the locking pins 18a and 18b to be depressed below the locking slots 22a and 22b, while the pushbuttons 20a and 20b are still retained within the pin receiving holes 24a and 24b. This allows clearance of the locking pins 18a and 18b from locking slots 22a and 22b, while the push button portions 20a and 20b of the hinge mechanism 16 are still retained within the receiving holes 24a and 24b, allowing the hinge device to unlock and swing into a desired angle. The spring could also be made to stay unlocked when desired, in other embodiments, as shown in FIG. 22, and allow an attached device to swing freely. FIG. 5 shows alternative embodiments for one of many possible spring mechanisms 16.

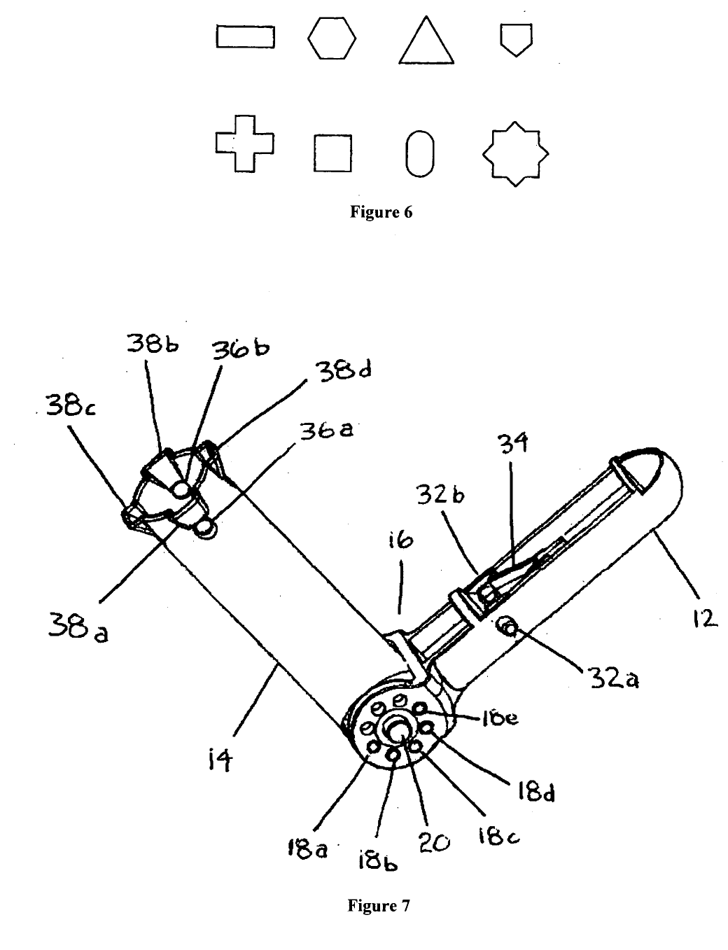

The embodiment shown in the FIGS. 1, 2, 3, 4, & 5 features locking pins 18a and 18b which are linearly aligned within the central pivoting axis, and are depicted such as to allow locked positions at a linear orientation, and at 90 degrees relative orientation between the two connector parts 12 and 14. Other locking mechanisms can also be employed within the scope of the present invention. For example, FIG. 6 shows a small selection of possible shapes for locking pins 18a and 18b, which are also linearly aligned within the central pivoting axis. Naturally, for these shapes of locking pins 18a and 18b to be used, the locking slots 22a and 22b would have to be sized and dimensioned to match accordingly. Obviously, a single locking pin 18a could alternatively be employed rather than a pair, although using a pair of locking pins 18a and 18b provides a stronger interlock with less wiggle room.

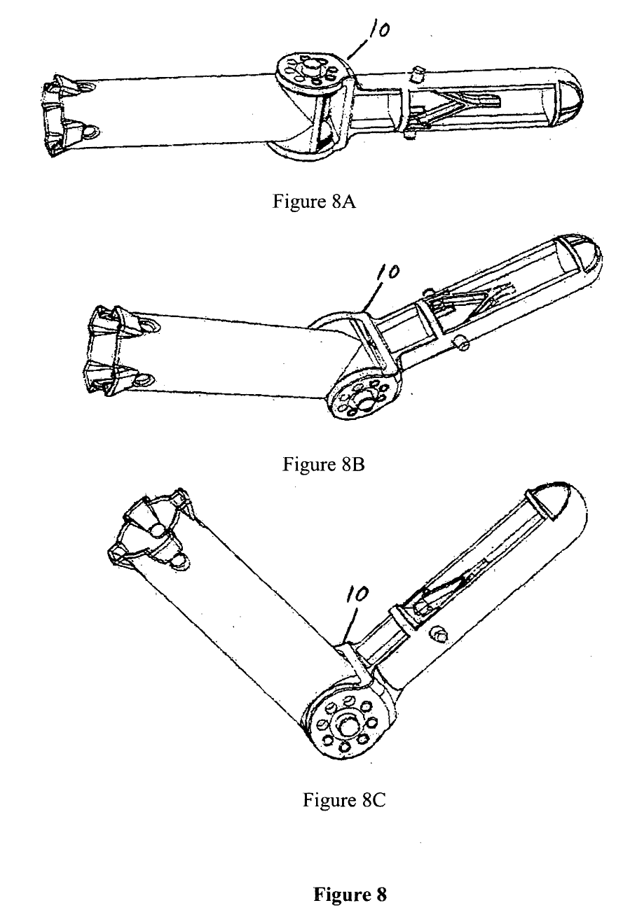

In another embodiment of a locking hinged connector apparatus, shown in FIG. 7, a different locking mechanism is depicted where there are multiple locking pins 18 on each end of the hinge mechanism, which makes the locking mechanism much stronger and more rigid than in the previously described embodiment. Another advantage of such an embodiment configuration is that this type of hinged connector apparatus 10 can be locked in several orientations, as shown in FIG. 8.

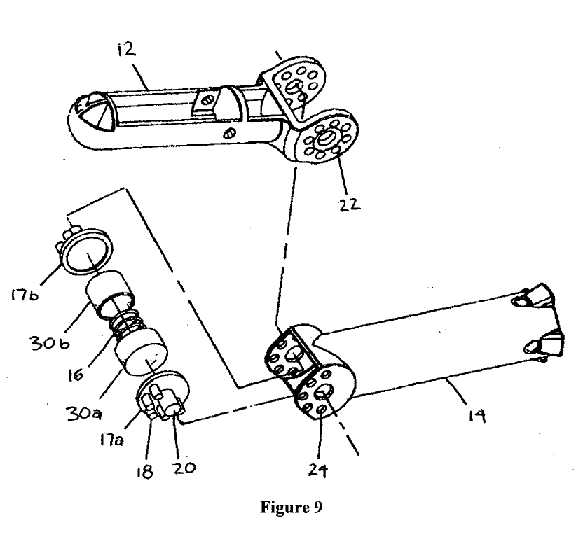

FIG. 9 shows an exploded view of such a locking hinged connection apparatus demonstrating the parts and components required to build this such embodiment. Each of these components can be made of molded plastic, metal, or of other suitable material which is suitably strong and durable for a desired usage. In a preferred embodiment, the spring 16 is made of metal and is enclosed in the two parts of a spring cup 30a and 30b, which are then capped on the outer ends with a pair of locking mechanism parts 17a and 17b. Each of the locking mechanism parts 17a and 17b comprise a number of locking pins, depicted here as 18a, 18b, 18c, 18d, and 18e, although more or less than five locking pins 18 can be employed on either side of the spring mechanism 16. The full assembly comprising spring 16, spring cup parts 30a and 30b, and the locking mechanisms 17a and 17b, are fitted within the hinge mechanism portion of a connector part 14. This assembly is then fitted with the locking hinge part of the connector 12. As with the previously described embodiment, the locking mechanism can be disengaged by pressing in the push buttons 20a and 20b, so that the locking pins 18a, 18b, 18c, 18d, and 18e are recessed towards the center of the hinged mechanism device sufficiently so that they no longer are in contact with the locking slots 22a, 22b, 22c, 22d, 22e, 22f, 22g, and 22h, and the two main connector parts 12 and 14 are free to rotate. When a desired angle of relative orientation between the two main connector parts is obtained, the push pins 20a and 20b are released, and the locking pins 18a, 18b, 18c, 18d, and 18e, are allowed to engage into whichever of the locking slots 22a, 22b, 22c, 22d, 22e, 22f, 22g, and 22h with which they are then aligned.

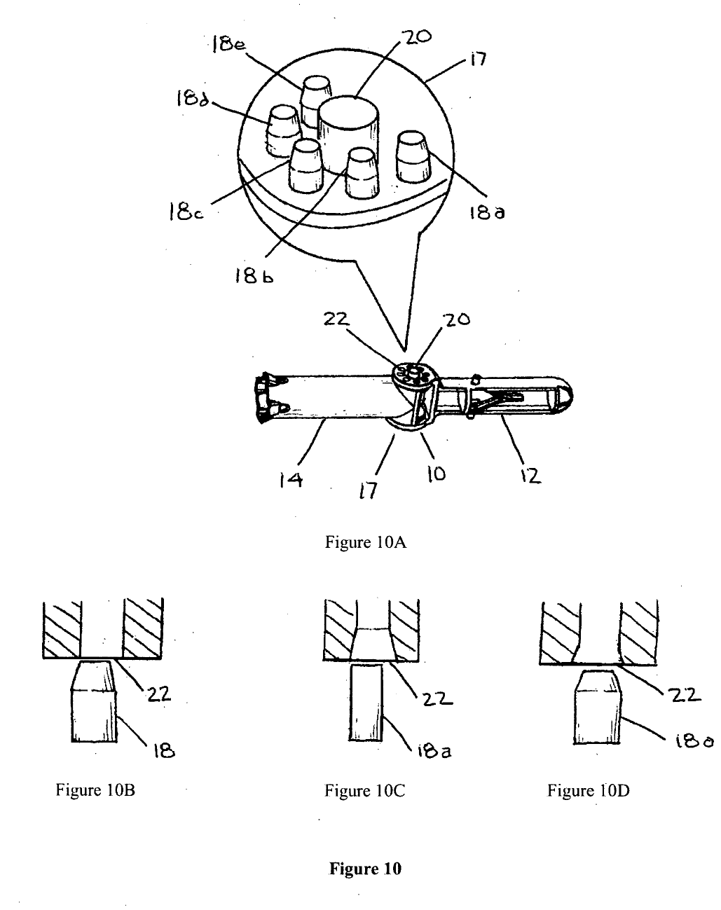

As shown in FIG. 10, locking pins 18a, 18b, 18c, 18d, and 18e can be tapered to enhance the ease with which the pins 18a, 18b, 18c, 18d, and 18e align and fit into the nearest aligned locking slots of 22a, 22b, 22c, 22d, 22e, 22f, 22g, and 22h. Similarly to the multiple locking slots 22 can also be tapered to further enhance the initial fit and alignment when the locking mechanism 17 is to be engaged.

Each of the aforementioned embodiments, and as shown clearly in FIG. 1, FIG. 7, FIG. 8 and FIG. 9, is depicted with connector parts sized and dimensioned to fit with standard quick connect swimming pool cleaning devices and handles, such as skimmer net devices, brushes and long poled handles and the like. Obviously, other types, styles, and sizes of connectors may also be used with an inventive locking hinged apparatus connector which is appropriately designed, as can be recognized and built by those skilled in the art. An example of another such connector style would be the usage of threaded connectors, sized and dimensioned to fit with industry standard paint roller handles, scrapers, push brooms and the like.

With the embodiments described herein which employ standard swimming pool cleaning device connector styles, as shown in FIG. 7, the connector apparatus can be made with a male connector 12 and a female connector 14. The dimensions of such a male connector 12 could be on the order of 1.125 inches outside diameter, while the dimensions of such a female connector 14 could be on the order of 1.125 inches inside diameter. The male connector 12 would further comprise one or more snap pins such as 32a and 32b. These snap pins 32a and 32b are common and well known in the swimming pool industry, and are typically spring loaded, often employing a wishbone shaped piece of nylon type springy plastic 34. The snap pins 32a and 32b are made to align with snap pin holes such as 36a and 36b, when the a male connector portion and a female portion are fully inserted together and engaged, as is also well known in the industry.

A novel feature of the connector apparatus as shown in FIG. 7 is the inclusion of flared snap pin receiving grooves 38a, 38b, 38c, and 38d. The flared snap pin receiving grooves 38a, 38b assist in both aligning snap pins such as 32a and 32b with the snap pin holes 36a and 36b, and they also assist in automatically depressing the spring loaded snap pins 32a and 32b as the approach the snap pin holes 36a and 36b, making the connection of male and female parts quicker and easier. By including a set of four snap pin holes 36a, 36b, 36c, and 36d, and four snap pin receiving grooves 38a, 38b, 38c, and 38d, a male connector part can be aligned and connected in more rotational orientations than can be obtained if only a set of two opposing snap pin holes 36a and 36b were employed.

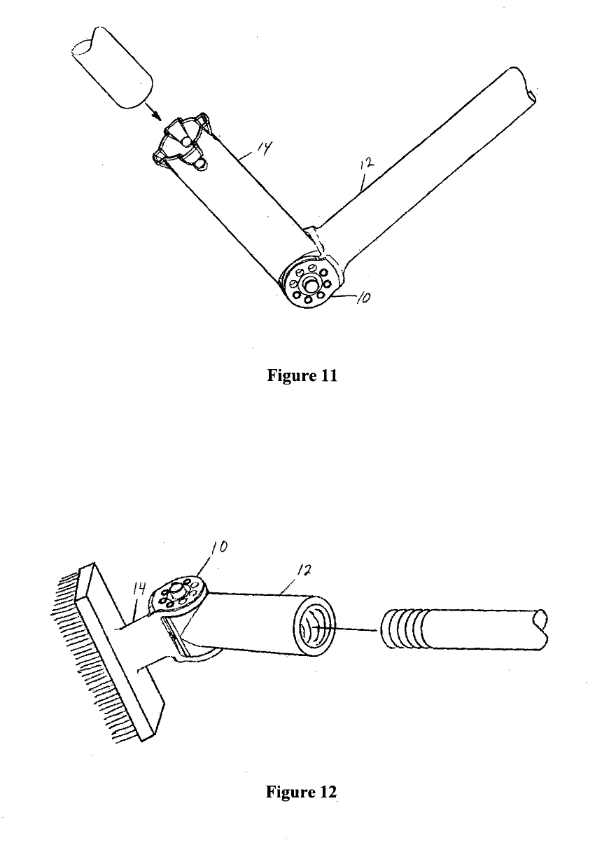

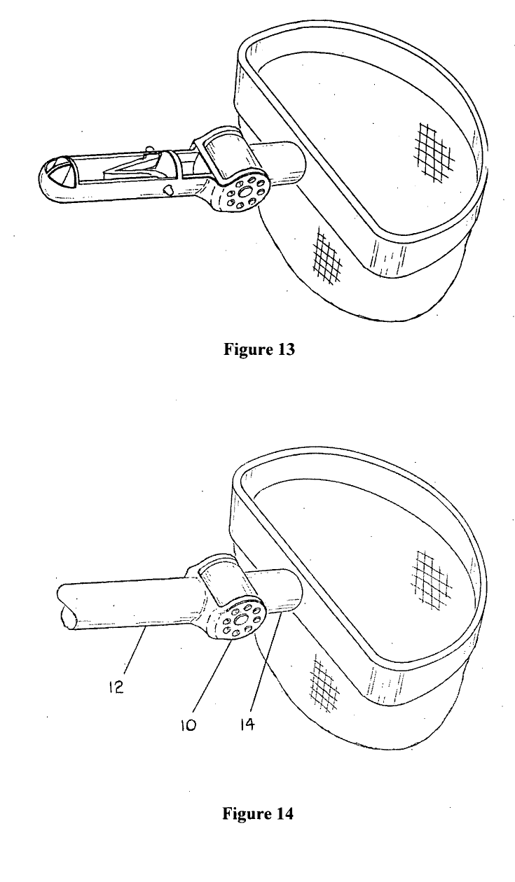

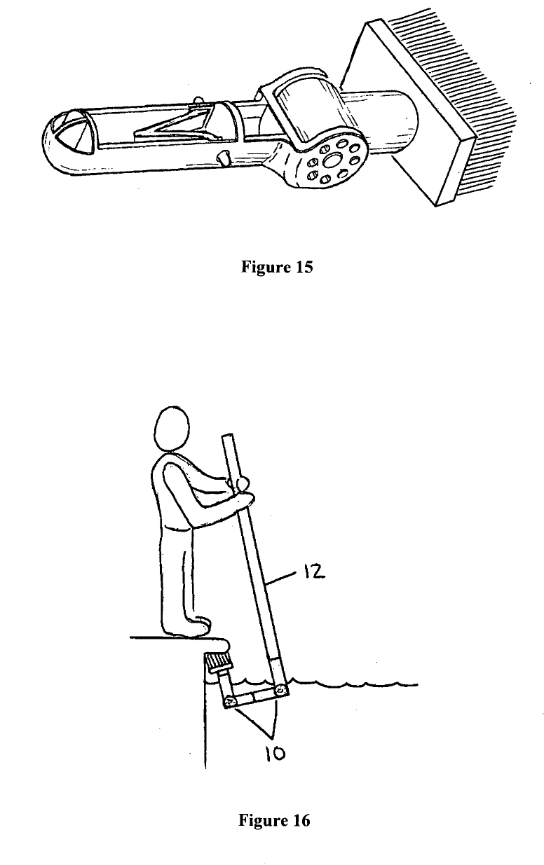

As shown in FIGS. 11, 12, 13, 14 and 15 each of the two main parts 12 and 14 which swing relative to each other can either be integrally fixed, or removably connected, such as to a pole, handle, or any number of useful work apparatus such as a brush or swimming pool skimmer. Thus, in different embodiments, the device can be either fixed or removably connected between any industry-standard pole handle on one end of the rotating element, and with an apparatus at the other end. In the case of a fixed pole or handle, the connector on the other side of the hinge may connect to an apparatus such as a brush, paint roller, etc. In the case of a fixed apparatus embodiment, the connector on the other side of the hinge may also connect to any industry-standard pole handle, such as one used for a paint roller, or a brush or one such as used for swimming pool cleaning handles, as well as any other desired connection type. A locking hinge apparatus could also be fixed to both the connector and apparatus on both sides, which would be a useful embodiment of the invention.

FIG. 16 shows two a locking hinge connector apparatuses 10 assembled in a series to give a complex multidimensional angle between a handle and an attached device. This may be useful in difficult to reach areas.

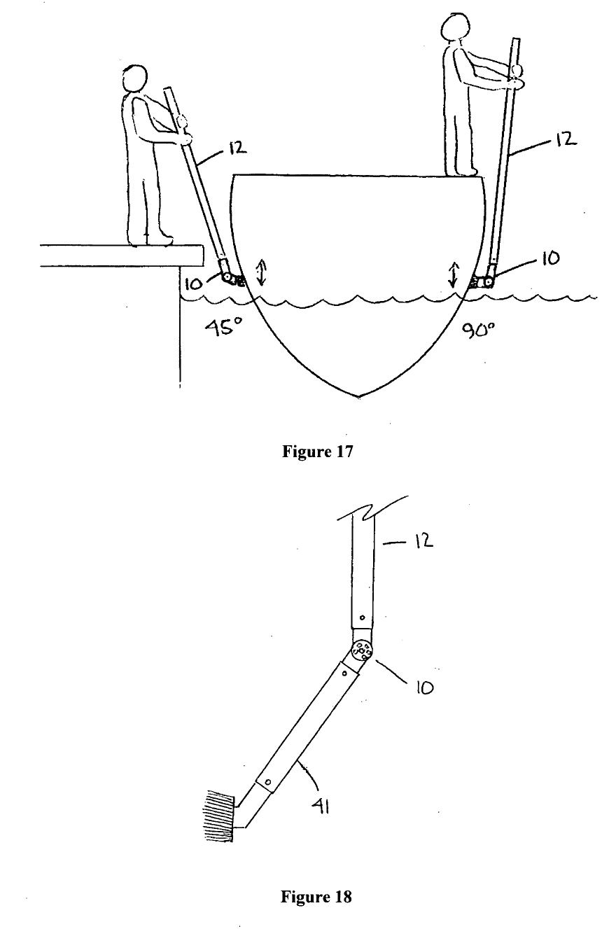

FIG. 17 shows a locking hinge connector apparatus 10 used to facilitate a boat cleaning operation where the locking hinge connector apparatus 10 is attached to a long handled pole on one end 12 and brush device on the other end. The locking hinge connector apparatus 10 can be unlocked, moved to a different orientation and relocked to more easily conform to the various angles of the boat hull surface relative to the location of the operator.

FIG. 18 shows a locking hinge connector apparatus 10 where a shorter extension 41 is connected between the locking hinge apparatus 10 and the attached device for use in difficult to reach areas where extra length 41 is required on the device side of the connection.

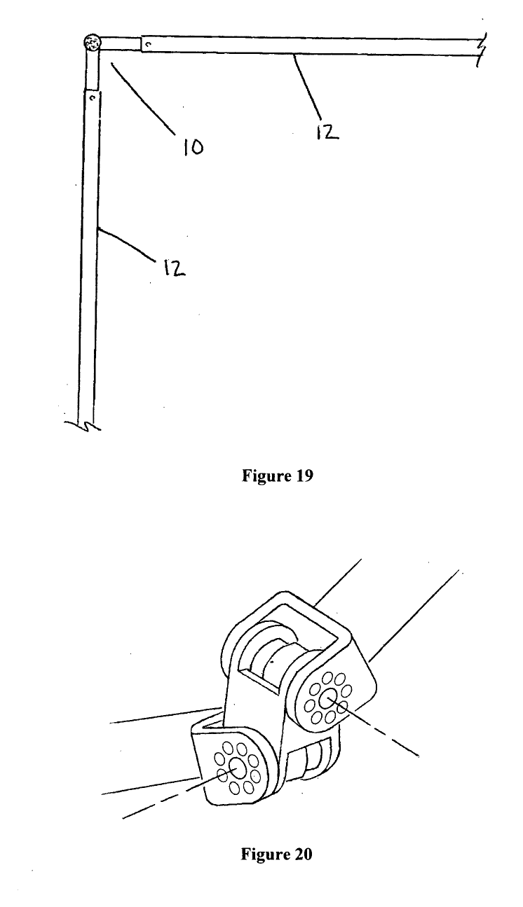

As shown in FIG. 19 two long handled poles 12 are attached to each end of a locking hinge connection apparatus 10 so one pole 12 assumes a 90 degree orientation to the other 12. A male-to-male embodiment of the locking hinge apparatus 10 as shown in FIG. 21 would be received by the female pole ends standard in the swimming pool industry. Such a configuration may be useful in measuring the depth in the center of large holes in the ground with the operator safely positioned on edge of the hole.

The device could also have a double hinge embodiment, allowing movement in both horizontal and vertical plains of operation, as shown in FIG. 20. This can be achieved by having both hinges fixed between or attached in many number of obvious ways. A combination of devices can be attached together to create a combination of various angles joined together.

FIG. 21 shows different connector configurations including female to female, male to male and male to female connector ends, such as the types used in standard swimming pool cleaning handles and devices.

FIG. 22 shows an example of a locking hinge connector apparatus where a separate piece is used to hold the locking pins in an unlocked configuration where the locking hinge connector apparatus is made to swing freely. Another embodiment of the unlocking function would employ a component integral with the locking hinge connector apparatus. This may be useful when the locking hinge connector apparatus (unlocked) is orientated to swing horizontally and connected to a pole connector that is orientated to swing vertically and is commonly included on such industry standard devices as vacuum heads. This connection configuration essentially forms a universal joint whereby rotating or twisting the pole handle causes the attached device (vacuum head) to steer to one side or the other during a bottom cleaning operation in a swimming pool.

FIG. 23 shows a locking hinge connector apparatus designed to connect to a handle one end and to a device on the other end, where both connector ends are designed with threaded connection fittings such as commonly found for use with paint rollers, scrapers, push brooms and other useful tools and devices. In some embodiments such threaded connections could be designed and sized to match with and attach to cameras, video equipment, tripod stands, telescopes and other useful devices.

FIG. 24A shows a locking hinge connector apparatus where two female connectors at a fixed angle relative to each other pivot relative to a male connector attached to a pole handle. FIG. 24B shows a locking hinge connector apparatus where one male connector end attached to a pole handle end and one female connector end are at a fixed angle relative to each other and a female connector end pivotally attached. FIG. 24C shows a locking hinge connector apparatus where one male connector end attached to a pole handle and one female connector end are fixed inline relative to each other and one female connector end pivotally attached.

FIG. 25 shows two various locking hinge connector apparatuses where a male connector end attaches to a pole handle and one or more female connector ends at fixed angles relative to each other are pivotally attached and where the female connector ends can receive devices by means of a threaded attachment mechanism.

FIG. 26 shows an operator during a sidewall cleaning process sidestepping parallel to the edge of a swimming pool manipulating a long handled pole connected directly (without locking hinge connector apparatus) to a standard skimmer net where the skimmer net is aligned parallel to the pole.

FIG. 27 shows an operator during a sidewall cleaning process walking parallel to the edge of a swimming pool pulling a long handled pole 12 and a locking hinge connector apparatus holding a standard skimmer net in a 90 degree orientation 10 to the pole handle with an inward angle of attack of the skimmer net relative to the sidewall of the pool.

What is claimed:

1) A hinge apparatus comprising two main connector parts,
Where each of the main parts is pivotally joined to the other main part by a hinge mechanism, and
Where at least one of the two joined main connector parts is attachable to a handle.

2) A hinge apparatus as in claim 1, where the hinge apparatus further comprises a locking/unlocking mechanism which locks the two main connector parts into a desired fixed non-linear angle relative to each other.

3) A hinge apparatus as in claim 2, where the main connector part which is attachable to a handle comprises a male type connector.

4) A hinge apparatus as in claim 3, where said male type connector part is approximately 1.125 inches outside diameter.

5) A hinge apparatus as in claim 2, where the main connector part which is attachable to a handle comprises a female type connector.

6) A hinge apparatus as in claim 5, where the female type connector comprises a threaded female type connector.

7) A hinge apparatus as in claim 2, where said locking/unlocking mechanism further comprises at least one spring loaded quick release push button.

8) A hinge apparatus as in claim 2, where said locking/unlocking mechanism further comprises at least one locking pin and at least one locking slot.

9) A hinge apparatus as in claim 2, where said locking/unlocking mechanism is constructed to be locked with a linear relative angle between the two main connector parts, and also can be locked with a relative angle orientation of approximately 90 degrees between the two main connector parts.

10) A hinge apparatus as in claim 2, where at least one of the two main connector parts is made at least partially of molded plastic.

11) A hinge apparatus comprising two main connector parts,
Where each of the main parts is pivotally joined to the other main part by a hinge mechanism, and
Where said hinge apparatus further comprises a locking/unlocking mechanism which locks the two main connector parts into a desired fixed non-linear angle relative to each other, and
Where at least one of said connector parts comprises a male type connector.

12) A hinge apparatus as in claim 11, where said male type connector part is approximately 1.125 inches outside diameter.

13) A hinge apparatus as in claim 11, where said male type connector part further comprises at least one spring loaded snap pin.

14) A hinge apparatus as in claim 11, where the first main connector part is a male type connector of approximately 1.125 inches outside diameter, and
Where the second main connector part is a female type connector of approximately 1.125 inches inside diameter.

15) A hinge apparatus as in claim 14, where said locking/unlocking mechanism is constructed to be locked with a linear relative angle between the two main connector parts, and also can be locked with a relative angle orientation of approximately 90 degrees between the two main connector parts.

16) A hinge apparatus as in claim 11, where said locking/unlocking mechanism is constructed to be locked with a linear relative angle between the two main connector parts, and also can be locked in relative angle orientations at approximately 45 degree increments between the two main connector parts.

17) A hinge apparatus as in claim 11, where the first main connector part is a male type connector of approximately 1.125 inches outside diameter, and
Where the second main connector part is attached to a net.

18) A hinge apparatus as in claim 11, where the first main connector part is a male type connector of approximately 1.125 inches outside diameter, and
Where the second main connector part is attached to a brush.

19) A hinge apparatus comprising two main connector parts,
Where each of the main parts is pivotally joined to the other main part by a hinge mechanism, and
Where said hinge apparatus further comprises a locking/unlocking mechanism which locks the two main connector parts into a desired fixed non-linear angle relative to each other, and
Where said locking/unlocking mechanism is constructed to be locked with a linear relative angle between the two main connector parts, and also can be locked in relative angle orientations at approximately 45 degree increments between the two main connector parts.

20) A hinge apparatus comprising two main connector parts, as in claim 19,
Where said locking/unlocking mechanism further comprises at least one locking pin and at least one locking slot.
